(19) United States
(12) Patent Application Publication
(10) Pub. No.: US 2014/0325524 A1
(43) Pub. Date: Oct. 30, 2014

(54) MULTILEVEL LOAD BALANCING

(71) Applicant: Hewlett-Packard Development Company, L.P., Houston, TX (US)

(72) Inventors: Pablo Sebastian Zangaro, Andover, MA (US); Ana Paula Salengue Scolari, Porto Alegre (BR)

(73) Assignee: Hewlett-Packard Development Company, L.P., Houston, TX (US)

(21) Appl. No.: 13/870,543

(22) Filed: Apr. 25, 2013

(51) Int. Cl. G06F 9/50

(52) U.S. Cl. CPC G06F 9/5083
USPC 718/105

(57) ABSTRACT

Example embodiments relate to multilevel load balancing. In example embodiments, a system may maintain a system-level queue of jobs. The system may maintain a pool of active processing nodes. Each active processing node in the pool may pull jobs from the system-level queue at an arrival rate for the particular active processing node. Each active processing node may determine a node-level utilization that indicates the particular active processing node's capacity to process jobs at the arrival rate. Each active processing node may adjust the arrival rate based on the node-level utilization. The system may determine a system-level utilization based the number of active processing nodes in the pool and average processing rates of the active processing nodes in the pool. Each average processing rate may indicate the time it takes the particular active processing node to process jobs once pulled from the system-level queue.

### BACKGROUND

Load balancing, in computing, relates to distributing workload across multiple computing units, storage units, communication links, or other resources. In a system that implements load balancing, a server may receive (e.g., from clients) workload items. The server may queue incoming workload items until they can be sent to one of the resources in the system. When a workload item is sent to one of the resources in the system (e.g., a computing unit), the resource may process the workload item. Load balancing aims to achieve optimal resource utilization, maximize throughput and minimal response time. A system may implement a load balancing scheme as software or hardware.

### BRIEF DESCRIPTION OF THE DRAWINGS

The following detailed description references the drawings, wherein:

FIG. 1A is a block diagram of an example network setup, where a scheme for multilevel load balancing may be used in such a network setup;

FIG. 1B is a block diagram of an example processing system that uses multilevel load balancing;

FIG. 2 is a block diagram of an example event receiver for multilevel load balancing;

FIG. 3 is a block diagram of an example processing node for multilevel load balancing;

FIG. 4 is a flowchart of an example method for multilevel load balancing;

FIG. 5 is a flowchart of an example method for multilevel load balancing;

FIG. 6 is a block diagram of an example event receiver computing device in communication with at least one example processing node computing device, for multilevel load balancing; and

FIG. 7 is a flowchart of an example method for multilevel load balancing.

### DETAILED DESCRIPTION

As described above, load balancing may relate to distributing workload across multiple resources in a system, for example, across multiple computing units. When workload items enter such a system, each item may need to be handled in a timely manner, for example, to meet the terms of a service level agreement established with clients and/or to ensure that the system does not become overloaded. A service level agreement (SLA) may refer to a contract of service between a service provider and at least one client/customer. If the system is already busy processing previous items, newly arriving workload items may be held in a queue (e.g., a system-level queue). If the system requires too much time to process each item, the queue length could grow, perhaps beyond the system's ability to process the items in the queue. This situation can lead to a violation of the SLA, or worse, a crash of the system and/or resources (e.g., computing units) in the system.

Various load balancing schemes may include a system-level service that monitors the resources (e.g., computing units) of the system to determine whether each resource can take on more or less work. Then, the system-level service may push or dispatch new workload items to resources that the system-level service determines are able to handle such workload items. In order for such a system-level dispatching scheme to work, the system-level service may need to track various pieces of information and metrics about the system and about the resources of the system. For example, the system-level service may need to maintain information about the topology of the system (e.g., number of computing units in the system, names and IP addresses of each computing unit, etc.). Additionally, the system-level service may need to track metrics for each resource (e.g., computing unit), for example, the resource's memory usage, storage usage, CPU usage, the status of any workload item queues in the resource, and the like.

In this scenario, the system-level service may track metrics that are only loosely related to the resources' ability to take on more or less work. For example, an application running on a resource (e.g., a computing unit) may be consuming a moderate amount of memory, CPU or the like, but internally, the application may be reaching a processing limit, which may reduce the processing rate of the application and the resource as a whole. In other words, most load balancing schemes are not “application aware,” and consequently, they may not optimally determine whether the resources of the system are underutilized or overloaded. Various other load balancing schemes may track (at a system-level) the processing rates of the resources, which may, to some degree, make these schemes application aware. However, these load balancing schemes still use a system-level service that must track and maintain metrics of all the resources in the system, for example, the processing rate of each resource. Such a system-level service may need to know, for example, specifically which processing rate is associated with which resource so that workload items may be pushed to the correct resource.

Various load balancing schemes use information (e.g., maintained at a system-level) about the ability of resources to take on more or less work to determine only which of the multiple resources to send new workload items to. Such schemes to do not determine whether more or less resources should be used, and do not cause new resources to be commissioned nor cause active resources to be decommissioned. Instead, the number of resources are determined ahead of time (e.g., by administrators). These numbers are often calculated or estimated based on empirical information, with little or no knowledge about the actual performance system. In fact, a study estimated that nearly 63 percent of administrators rely on manual checks, trial and error and/or waiting until a failure occurs to determine the number of resources required. Mistakes are often made in these estimations. Additionally, a fixed number of resources is not appropriate for many situations. For example, during a sudden peak in workload item arrivals, the system may become overloaded and may send workload items to resources that cannot process the workload items (e.g., an error may occur), or the system may have to reduce the overall rate at which the system can receive workload items (which may violate an SLA). Likewise, during a slow period of workload item arrivals, the system may include multiple resources that are significantly underutilized.

The present disclosure describes a scheme for multilevel load balancing. The present disclosure describes a system that uses a system-level load balancer as well as load balancers at the level of each resource (referred to herein as “processing nodes”). In this respect, each processing node, via its node-level load balancer monitors its own utilization, and each processing node knows when it can handle more or less work. Each processing node may then alter its own workload item arrival rate. In this respect, each processing node may be self-balancing. Additionally, each processing node determines its utilization based on the processing node's actual ability to process (e.g., via an application running on the resource) workload items. In this respect, each processing node is application-aware. The present disclosure describes a load balancing scheme where processing nodes pull workload items from a system-level queue, instead of the workload items being pushed to them. Because workload items are not pushed to resources, a system-level computing unit may need to maintain very little information about the system (e.g., the topology of the system) and the individual resources or nodes of the system. Instead, the system may only need to know the number of active processing nodes in the system and average workload item processing times for processing nodes (e.g., processing times that are unassociated with any particular processing node), and then the system can calculate the overall utilization of the system.

Based on the overall utilization, according to the present disclosure, the system may automatically and dynamically commission or activate new processing nodes (e.g., from a pool of available inactive processing nodes) or automatically decommission active processing nodes (e.g., such that these processing nodes may be shut down, put on standby or used by other systems or applications). Because processing nodes may monitor their own utilization, and because little information about the processing nodes is maintained at the system-level, adding or removing active processing nodes from the system is easy. Essentially, the processing nodes handle their own commissioning or decommissioning, and all the system needs to know is that more or less processing nodes are pulling workload items from the system-level queue. Automatic and dynamic commissioning/decommissioning may also provide benefits over systems where the number of resources is set ahead of time. The load balancing scheme described herein may be able to handle peaks in workload item arrivals. Additionally, the load balancing scheme may reduce the number of active but unused resources. Studies have revealed that millions of servers in data centers are performing very little processing and are wasting energy and money just to be ready for a peak in workload. According to the present disclosure, unused or underutilized resources may be decommissioned, which may save energy and money. Automatic commissioning/decommissioning may also make the system highly scalable. Additionally, the system may provide information (e.g., overall utilization and/or average overall waiting time to respond to events) to system administrators, which may allow administrators to tune the system and/or estimate future hardware/infrastructure needs.

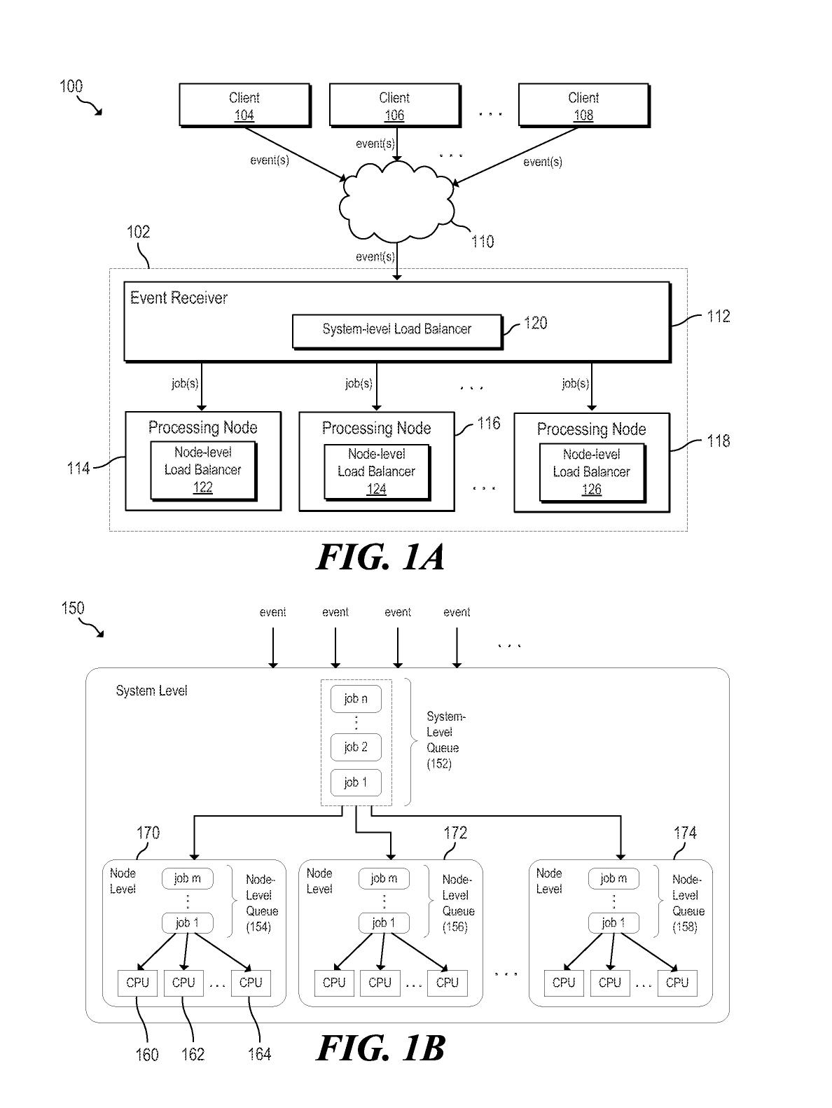

FIG. 1A is a block diagram of an example network setup 100, where a scheme for multilevel load balancing may be used in such a network setup. Network setup 100 may include a processing system 102. Network setup 100 may include a number of clients (e.g., clients 104, 106, 108), which may be in communication with processing system 102, for example, via a network (e.g., network 110). In alternate embodiments, clients 104, 106, 108 may be connected directly to processing system 102, e.g., without a network 110. Network 110 may be a wired or wireless, and may include any number of hubs, routers, switches or the like. Network 110 may be, for example, part of the internet, an intranet or other type of network. Clients 104, 106, 108 may send (e.g., via network 110) events to processing system 102.

Processing system 102 may include an event receiver 112 and multiple processing nodes (e.g., processing nodes 114, 116, 118). Event receiver 112 may be connected or coupled to the processing nodes, for example, directly or indirectly (e.g., via a network, hub(s), router(s), switch(es) or the like). Event receiver 112 may receive events from clients and may send jobs to various processing nodes in the system. Each job may be related to at least one of the events. Event receiver 112 may be implemented by at least one computing device that is capable of receiving events from clients and sending jobs to processing nodes. Each processing node 114, 116, 118 may be implemented by at least one computing device that is capable of receiving jobs from event receiver 112 and processing such jobs. In some embodiments, each of the event receiver 112 and processing nodes 114, 116, 118 may be implemented by a separate computing device. In some embodiments, two or more of these may be implemented by the same computing device, e.g., utilizing virtualization. Therefore, processing system 102 may include one or more computing devices. The term system may be used to refer to either a single computing device or multiple computing devices. The term computing unit may be used to refer to a computing device or a virtual computing device that is provided by a physical computing device, where the physical computing device may provide multiple virtual computing devices.

Each processing node in the system (e.g., 114, 116, 118) may be a resource in a multi-resource system (e.g., system 100). For purposes of explanation in this disclosure, each processing node may be a computing unit that may run at least one application, wherein the applications of the processing nodes may process workload items. Other examples of resources or processing nodes include storage units, web servers, communication links, or any other type of resource. Each processing node in the system (e.g., 114, 116, 118) may be active or inactive. Active processing nodes are processing nodes that are online (i.e., running and connected) and available to process jobs from event receiver 112. Inactive processing nodes are processing nodes that are offline, shutdown, on standby or otherwise not currently processing jobs from event receiver 112. Event receiver 112 may be able to communicate with all processing nodes of the system whether they are active or inactive. In this respect, event receiver 112 may be able to activate (or commission) inactive processing nodes or deactivate (or decommission) active processing nodes. For the purposes of various descriptions below, processing nodes 114, 116 and 118 may be active processing nodes and inactive processing nodes of the system 102 may not be shown in FIG. 1A.

It should be understood that, throughout this disclosure with respect to the multilevel load balancing scheme described herein, when reference is made to “sending” jobs from the event receiver to the processing nodes, the jobs are being sent in response to the processing nodes “pulling” or requesting the jobs from the event receiver. Throughout this disclosure, the term “event” may refer to a workload item that is external to the system or entering the system. The term “job” may refer to a workload item that is internal to the system. Events and jobs may be similar in that they include information about routines or tasks that should be performed; however, a processing system may perform some initial processing on an event to prepare it for handling by the system. Therefore, the term job may be used to refer to a routine or task that is created by initially processing one or more events. In some examples one event may result in multiple jobs or multiple events may be initially processed into one job.

Throughout this disclosure, the term “pool” may be used to refer to multiple processing nodes, for example, multiple active processing nodes, multiple inactive processing nodes or multiple processing nodes that may be either active or inactive. As one specific example, the term pool may be used to refer to all the processing nodes that may be in communication with an event receiver (e.g., 112), whether the processing nodes in the pool are active or inactive. As another specific example, all active processing nodes that are available to an event receiver may be considered a pool, and all inactive processing nodes accessible by an event receiver may be referred to as a pool. In this respect, when an inactive processing node is activated (or commissioned), it may be said that the processing node is added to the pool of active processing nodes. Likewise, when an active processing node is deactivated (or decommissioned), it may be said that the processing node is removed from the pool of active processing nodes.

It may be beneficial to describe one specific example scenario to explain the concept of a processing system, events and jobs. Referring to FIG. 1A, suppose that processing system 102 is a system that receives and processes support requests. For example, customers that purchase a business server may submit requests for support if some issue arises where they may need help from the provider of the business server. In this example, clients 104, 106, 108 may be computing devices that various customers use to submit support requests to the provider, and processing system 102 may be maintained by the provider to handle such support requests. In this situation, the term event may refer to the raw request data as it is sent from a client device to the processing system 102. Processing system 102 may perform initial processing on each event to create at least one job. Each job may be some task or routine that the processing system must perform in response to the event. For example, when a support request event is received, the processing system may perform the following tasks (i.e., jobs): open a support ticket, determine details about the service requested, check a subscription list for the type of service requested, send a message to each recipient in the subscription list, etc. Certain tasks may have to be completed before a response can be sent to the client. A service level agreement (SLA) between the provider and the clients may establish certain rules that must be followed regarding the responsiveness of the provider. For example, an SLA may require that the provider contact the client within 30 minutes of receiving a support request.

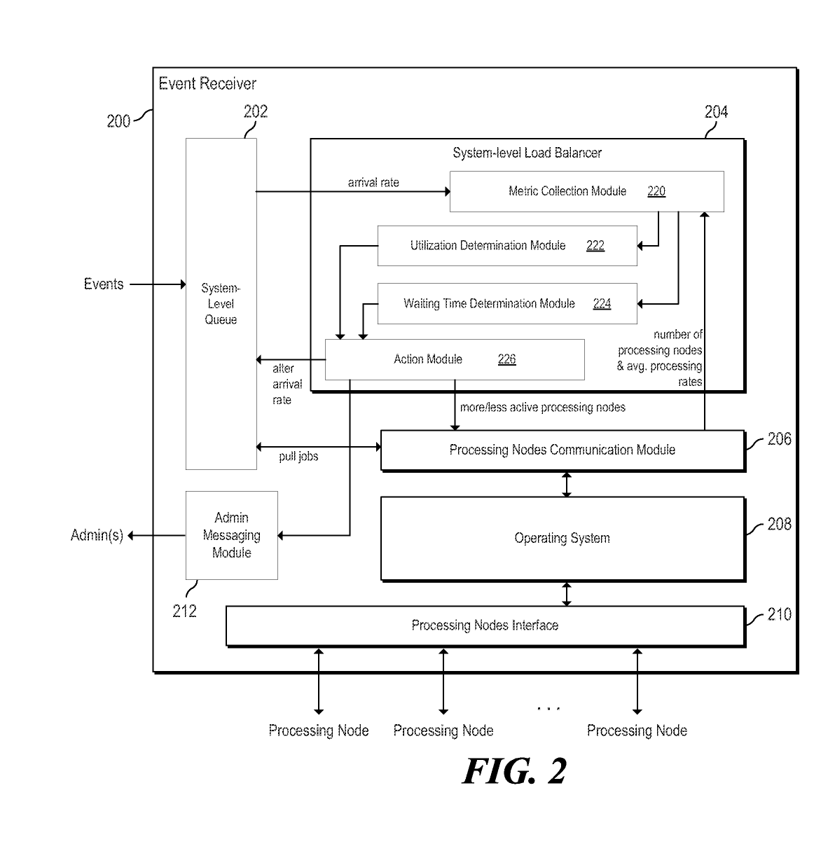

Event receiver 112 may receive events from clients (e.g., clients 104, 106, 108) and may initially process the events to create one or more jobs. Event receiver 112 may send each job to a particular processing node for processing (e.g., in response to the particular processing node “pulling” or requesting the jobs). Event receiver 112 may include a system-level load balancer 120, which may facilitate the scheme for multilevel load balancing described herein. Event receiver 112 may include a series of instructions encoded on a machine-readable storage medium and executable by a processor accessible by the event receiver. In addition or as an alternative, system-level load balancer may include one or more hardware devices including electronic circuitry for implementing the functionality of the system-level load balancer described below. More details regarding an example event receiver and an example system-level load balancer may be provided below, for example, with regard to event receiver 200 and system-level load balancer 204 of FIG. 2.

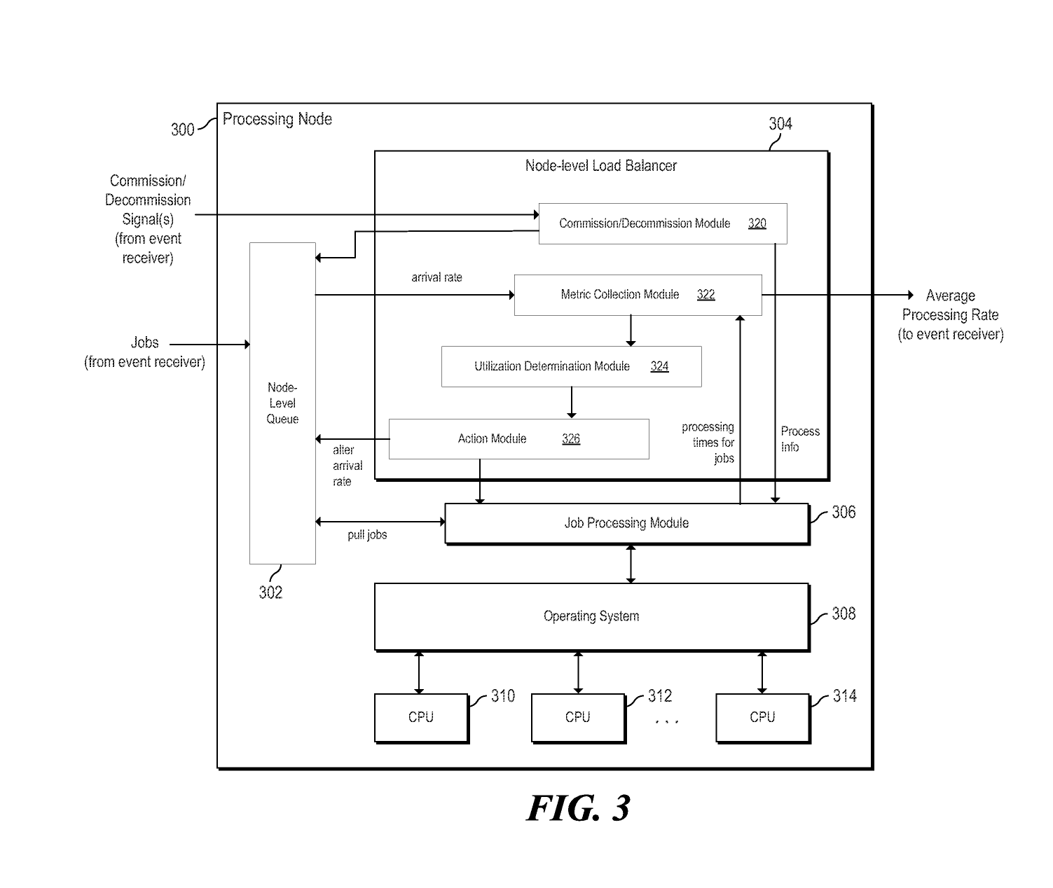

Processing nodes 114, 116, 118 may receive jobs from event receiver 112 and may process such jobs. Processing nodes 114, 116, 118 may each include a node-level load balancer (e.g., respectively, node-level load balancers 122, 124, 126). Each node-level load balancer may facilitate the scheme for multilevel load balancing described herein. Each node-level load balancer may include a series of instructions encoded on a machine-readable storage medium and executable by a processor accessible by the particular processing node. In addition or as an alternative, each node-level load balancer may include one or more hardware devices including electronic circuitry for implementing the functionality of the node-level load balancer described below. More details regarding an example processing node and an example node-level load balancer may be provided below, for example, with regard to processing node 300 and node-level load balancer 304 of FIG. 3.

FIG. 1B is a block diagram of an example processing system 150 that uses multilevel load balancing. Processing system 150 may be similar to processing system 102 of FIG. 1A, for example. As can be seen in FIG. 1B, processing system 150 may receive a number of events, for example, from clients 104, 106, 108 of FIG. 1A. Processing system 150 may include and maintain a system-level queue 152. System-level queue may be included in an event receiver (e.g., event receiver 112 of FIG. 1A). As shown in FIG. 1B, system-level queue 152 may include a number of jobs (e.g. job 1, job 2, . . . , job n). When events enter processing system 150, an event receiver may perform initial processing on the events to create one or more jobs. Then, the event receiver may place the one or more jobs in system-level queue 152. Each job may remain in system-level queue 152 until a processing node (e.g., processing node 170, 172 or 174) pulls or requests the job from the system-level queue. Processing nodes 170, 172, 174 may be similar to processing nodes 114, 116, 118, for example. Thus, it can be seen in FIG. 1B that each job in system-level queue 152 may be sent to one of the processing nodes, at which point, the job may be handled at the node-level.

As can be seen in FIG. 1B, each processing node (e.g., 170, 172, 174) may maintain its own node-level queue (e.g., node-level queues 154, 156, 158). Each node-level queue may include a number of jobs (e.g. job 1, job 2, . . . , job m). Each processing node, once it pulls or requests a job from system-level queue 152, may place the job in its node-level queue. Each job may remain in the node-level queue until a central processing unit (CPU) or CPU core accessible by the processing node is free to process the job. Thus, it can be seen, as one example, that each job in node-level queue 154 is sent to one of its accessible CPUs (e.g., 160, 162, 164), at which point, the job may be processed by the CPU. It should be understood that in some embodiments, each processing node may have its own dedicated set of CPUs or CPU cores. In other embodiments, CPUs may be shared by more than one processing node. In some embodiments, where reference is made to a CPU (e.g., in FIG. 1B), in actuality, a CPU core may be used. Therefore, processing nodes may assign jobs to CPU cores.

Continuing with the specific example scenario of a processing system that receives and processes support requests (e.g., from customers that purchased business servers), when the processing system 150 receives events (e.g., support requests) from customers, processing system 150 may initially process each support request and then place it as at least one job in system-level queue 152. For example, one job may include opening a support ticket. Another job may include checking a subscription list to determine recipients of messages. Each job may wait in system-level queue 152 until a processing node pulls or requests the job and places it in its node-level queue (e.g., 154). The processing node may eventually assign the job to one of its CPUs (or CPU cores) for processing.

FIG. 2 is a block diagram of an example event receiver 200 for multilevel load balancing. Event receiver 200 may be similar to event receiver 112 of FIG. 1A, for example. Event receiver 200 may include a system-level queue 202 and a system-level load balancer 204. Event receiver 200 may include at least one of a processing nodes communication module 206, an operating system 208, a processing nodes interface 210 and an admin messaging module 212.

System-level queue 202 may be used by event receiver 200 to receive events and store events or jobs until jobs are pulled or requested by processing nodes. System-level queue 202 may include a module that performs initial processing on incoming events to create at least one job for each event. In alternate embodiments, the initial processing module may be external to system-level queue 202. Jobs may then be stored in system-level queue 202. System-level queue 202 may allow processing nodes to request or pull jobs, for example, via at least one of module 206, operating system 208 and interface 210. System-level queue 202 may receive events (e.g., from clients) at a specified arrival rate. System-level queue 202 may set and maintain its own arrival rate. System-level queue 202 may alter its arrival rate at various times and based on various input(s), e.g., input from module 226. System-level queue 202 may provide its arrival rate (e.g., as a performance metric) to other modules of the event receiver 200, for example, to module 220. System-level queue 202 may include a series of instructions encoded on a machine-readable storage medium and executable by a processor accessible by the event receiver. In addition or as an alternative, system-level queue 202 may include one or more hardware devices including electronic circuitry for implementing the functionality of the system-level queue described herein.

Processing nodes communication module 206 may allow event receiver 200 to communicate with multiple processing nodes in the processing system. Processing nodes communication module 206 may communicate with an operating system 208 of the event receiver 200 to communicate with processing nodes. Operating system 208 may, in turn, communicate with at least one processing nodes interface 210 to communicate with processing nodes. Processing nodes interface 210 may include hardware and firmware (e.g., drivers) to facilitate communication between operating system 208 and at least one processing node. Processing nodes communication module 206 may allow processing nodes to request or pull jobs from system-level queue 202, in which case, the job may be removed from system-level queue 202 and communicated to the appropriate processing node for node-level processing.

Processing nodes communication module 206 may detect the existence of processing nodes (e.g., active processing nodes) in the system, and may provide such information (e.g., the number of active processing nodes) to system-level load balancer 204 (e.g., to module 220). Processing nodes communication module 206 may also receive, from active processing nodes in the system, average processing rates (e.g., one per node). An average processing rate may indicate, for a particular processing node, on average, how long it takes the processing node to process a job from the moment the job is received by the process node to the time the job has completed being processed in the processing node. An average processing rate, for example, may be based on an average amount of time required for a number (e.g., 5, 10, 15, etc.) of jobs to be processed by a processing node per period of time, e.g., 5 jobs per second. In the example scenario of processing support requests, the processing rate may be 10 requests per minute, for example.

In some embodiments and/or scenarios, the average processing rates received by module 206 may be unassociated with any particular processing node. In other words, the average processing rates may be anonymous. Alternatively, even if such association information is available, module 206 may not capture such information because system-level load balancer 204 may not need to maintain such association information. Processing nodes communication module 206 may provide the average processing rates (e.g., μ₁, μ₂, etc.) to system-level load balancer 204 (e.g., to module 220). Alternatively, processing nodes communication module 206 may determine a super average processing rate (e.g., an average of all the average processing rates of the active processing nodes), and may provide the super average processing rate (e.g., μ) to system-level load balancer 204 (e.g., to module 220). The super average processing rate may still be a per-node processing rate, but it may be a single value that considers the average processing rates of all the active nodes in the system. If module 206 computes a super average processing rate, the output of that rate may simply be referred to as an average processing rate or an average per-node processing rate, for further descriptions.

Processing nodes communication module 206 may allow system-level load balancer 204 to after the number of active/inactive processing nodes. Processing nodes communication module 206 may, for example, indicate to an inactive processing node in the system that it should be activated or commissioned. As another example, processing nodes communication module 206 may indicate to an active processing node in the system that it should be deactivated or decommissioned.

System-level load balancer 204 may facilitate (at least in part) a scheme for multilevel load balancing described herein. System-level load balancer 204 may determine the overall utilization of the processing system. System-level load balancer 204 may receive various metrics (e.g., arrival rate) from system-level queue 202 and various metrics (e.g., average processing rate(s)) from module 206 in order to determine the overall utilization. System-level load balancer 204 may take various actions based on the overall utilization. For example, system-level load balancer 204 may cause (e.g., via module 226) the system-level queue 202 to alter its arrival rate. As another example, system-level load balancer 204 may cause (e.g., via module 226) more or less processing nodes to be active (e.g., available to pull jobs from system-level queue 202). System-level load balancer 204 may include a number of modules, for example, modules 220, 222, 224, 226. System-level load balancer 204 (and various included modules such as modules 220, 222, 224, 226) may include a series of instructions encoded on a machine-readable storage medium and executable by a processor accessible by the event receiver 200. In addition or as an alternative, system-level load balancer 204 (and various included modules such as modules 220, 222, 224, 226) may include one or more hardware devices including electronic circuitry for implementing the functionality described herein.

System-level load balancer 204 may use a queuing theory to facilitate multilevel load balancing, as described herein. The term “queuing theory” refers generally to a mathematical model that allows queue-driven systems to be modeled. System-level load balancer 204 may use queuing theory to build a model of the system (e.g., system 100). The particular queuing theory model may change depending on various factors of the system, for example, arrival rates, response waiting times, number of processing nodes, average processing rate(s), and capacity of queues. System-level load balancer 204 may use queuing theory to analyze information and metrics about the system and the system-level queue to determine whether the system can handle the current workload with the current number of processing nodes, arrival rate, processing rates, etc. System-level load balancer 204 may receive these metrics in real-time and may perform various actions to control the system load.

Metric collection module 220 may receive and maintain various metrics that the system-level load balancer 204 may use to calculate various items (e.g., overall utilization, overall average waiting time, etc.). Metric collection module 220 may receive a system-level arrival rate from system-level queue 202. Metric collection module 220 may receive at least one average processing rate from processing nodes communication module 206. Metric collection module 220 may receive a super average processing rate (described above) that accounts for all the active processing nodes and/or it may receive multiple average processing rates (e.g., μ₁, μ₂, etc.), one for each active processing node that is pulling jobs from system-level queue 202. If metric collection module 220 receives multiple average processing rates, metric collection module 220 may compute a super average processing rate, e.g., in a manner similar to the way module 206 may compute a super average processing rate. As explained above, the average processing rates received by module 220 may be unassociated with any particular processing node (e.g., anonymous).

Metric collection module 220 may not need to collect detailed information about the particular processing nodes that are pulling jobs. Instead, it may just collect average processing rates for a specified number of processing nodes, for example, where the average processing rates are unassociated with any particular processing node (e.g., anonymous). Metric collection module 220 may receive information (e.g., from module 206) about how many processing nodes are active. Again, this may be minimal information, for example, about a number of active processing nodes. Module 220 may not need to maintain any detailed information about the processing nodes (e.g., names, IP addresses, resource usage metrics, etc.). Metric collection module 220 may provide metrics information (e.g., arrival rate and a super average processing rate) to other modules of the system-level load balancer 204, for example, module 222 and/or module 224. Even though the processing rate output by module 220 may be a super average processing rate, in other descriptions it may just be referred to as an average processing rate or an average per-node processing rate.

Utilization determination module 222 may determine the overall utilization of the processing system (e.g. processing system 100). The symbol ρ may be used to represent utilization throughout this application. At the system-level, ρ may represent the overall utilization of the system, whereas, at the node-level level, ρ may represent the utilization of the particular node. Utilization generally indicates the ability of the system or processing node to handle incoming events or jobs at the current arrival rate. At the system-level, utilization (ρ) may be based on the overall arrival rate (e.g., represented by the symbol λ) of events into the system (e.g., into system-level queue 202) and an average per-node processing rate (e.g., represented by the symbol μ).

The arrival rate may be measured by the system-level queue 202 and may be received by module 220. The average per-node processing rate may be measured and/or calculated by modules 206 and/or 220. Module 220 may also determine the number of active processing nodes (e.g., by receiving information from module 206). Utilization determination module 222 may then calculate overall utilization, ρ, as shown below in Equation 1 (Eq. 1). Eq. 1 calculates the utilization, ρ, where λ represents the overall arrival rate, where μ represents the average per-node processing rate and where s represents the number of active processing nodes.

$$ρ = \frac{s μ}{} \qquad ( Eq . 1 )$$

Utilization, ρ, may be a number between 0 and 1 (e.g., including decimal numbers). Utilization determination module 222 (or action module 226) may use the utilization to determine if the system is in a “steady state,” i.e., to determine whether the system can handle incoming events at the current arrival rate and processing rate or whether they system is overloaded. System-level load balancer 204 may have determined (e.g., using queuing theory models) that the system can handle the workload with the current number of processing nodes, current arrival rate, etc., as long as the system stays in a stead state. The system may be in a steady state if ρ is below a first threshold. For the purposes of this disclosure, 0.9 will be used for the first threshold. Other threshold values of approximately 0.9 (e.g., 0.9 plus or minus a certain percentage of 1, such as 2 percent, 3 percent, 5 percent, etc.) may be used. Additionally, other threshold values may be used, for example, 0.8, 0.85, 0.95, etc. If ρ is above the first threshold, this may indicate that the system is near collapse (e.g., unable to keep up with processing the incoming events at the current arrival rate).

In a similar manner, utilization determination module 222 (or action module 226) may use the utilization to determine whether the system is underutilized. System-level load balancer 204 may have determined (e.g., using queuing theory models) that the system can handle the current workload (e.g., process all incoming events within times required by an SLA) with fewer processing nodes whenever the utilization drops below a second threshold. For the purposes of this disclosure, 0.6 will be used for the second threshold. Other threshold values of approximately 0.6 (e.g., 0.6 plus or minus a certain percentage of 1, such as 2 percent, 3 percent, 5 percent, 10 percent, etc.) may be used. Additionally, other threshold values may be used, for example, 0.5, 0.55, 0.65, 0.7, etc. If ρ is below the second threshold, this may indicate that the system is underutilized. Thus, if the second threshold is 0.6, and the first threshold is 0.9, then the system is steady and not underutilized whenever ρ is between (e.g., including) 0.6 and 0.9.

Waiting time determination module 224 may determine the average total waiting time (i.e., average total processing time) of events at the system-level. Total waiting time may include the time period between when event receiver 200 receives an event and when the job(s) related to the event are fully processed such that a response can be communicated to the client. If the event caused multiple jobs to be created, the total waiting time may include the time to process all related jobs. Total waiting time may include the time a job spends in the system-level queue 202 plus the time required for handling by a processing node. Handling time by a processing node may include time spent in a node-level queue and time required to process the job, e.g., by a CPU of the processing node.

Waiting time determination module 224 may provide the average total waiting time to system administrators (e.g., via module 226 and perhaps via an admin messaging module 212). Administrators may use the average total waiting time to determine whether the performance of the system is meeting the requirements of an SLA (service level agreement). An administrator may take various actions based on the average total wait time, for example, adjusting the first and second utilization thresholds discussed above, adding more processing nodes to the system, etc. Additionally, an administrator may alter the jobs that are performed in response to various events in order to enhance the performance of the system. For example, in the scenario of a support request processing system, an administrator may reduce the number of messages that are sent to recipients, e.g., by modifying at least one subscription list. Additionally, an administrator (or the system, automatically) may alter priorities (e.g., order) of jobs in the system level queue (e.g., 202). For example, jobs that are associated with a stricter SLA may get a higher priority. Specifically, if a job in the system-level queue has an estimated waiting time that is greater than some determine value specified in the SLA, the administrator (or the system, automatically) may prioritize the job (e.g., alter its order in the queue).

Waiting time determination module 224 may determine the average total waiting time based on the overall arrival rate (λ) of events into the system and the average per-node processing rate (μ). Overall arrival rate and average per-node processing rate are the same values/metrics as explained above with regard to calculating utilization. Waiting time determination module 224 may calculate average overall waiting time, W, as shown below in Eq. 2 below.

$$\begin{matrix}W = {W}_{q} + \frac{1}{μ} & ( Eq . 2 ) \\ {W}_{q} = \frac{{L}_{q}}{} & ( Eq . 3 ) \\ {L}_{q} = \frac{{{P}_{0} ( / μ )}^{s}}{s 1 {( 1 - ρ )}^{2}} {P}_{0} & ( Eq . 4 ) \\ {P}_{0} = \frac{1}{( {\sum }_{n = 0}^{∞} \frac{{( / μ )}^{n}}{n !} + \frac{{( / μ )}^{s}}{s ! ( 1 - / s μ )} )} & ( Eq . 5 )\end{matrix}$$

In Eq. 2 above, W_{q} may represent the average waiting time in the system queue (e.g., 202). W_{q} may be expanded in Eq. 3 above. In Eq. 3, L_{q} may represent the average length (e.g., how many jobs in the queue) of the system-level queue. L_{q} may be expanded in Eq. 4 above. In Eq. 4, P₀ may represent the probability of zero jobs being in the system (i.e., no jobs in the system-level queue and no jobs in any processing nodes), and as explained above, s may represent the number of active processing nodes in the system. P₀ may be expanded in Eq. 5 above.

Action module 226 may perform various actions depending on the overall utilization (e.g., calculated by module 222) and/or the average overall waiting time (e.g., calculated by module 224). Action module 226 may receive the overall utilization (or some calculation or conclusion based on the overall utilization) from utilization determination module 222. As explained above, if the utilization (ρ) is greater than a first threshold (e.g., 0.9), the system may be overloaded. If the system is overloaded, the system will likely fail in time. For example, the system-level queue may grow, and the system may collapse due to lack of system resources. In response to the overall utilization being greater than a first threshold, action module 226 may cause the system-level queue 202 to alter (e.g., reduce) its arrival rate. In some situations, decreasing the arrival rate of the system may not be desirable, for example, because this may result in violation of an SLA. Therefore, the present disclosure describes a solution where additional processing nodes may be activated or commissioned. Thus, in response to the overall utilization being greater than a first threshold, action module 226 may communicate (e.g., via module 206) with at least one inactive processing node, and may indicate to the processing node that it should become active. Action module 226 may calculate the number of additional processing nodes that are required to meet the current workload, and then may automatically commission them.

Likewise, action module 226 may automatically decommission processing nodes. As explained above, if the utilization (ρ) is less than a second threshold (e.g., 0.6), the system may be underutilized. In response to the overall utilization being less than the second threshold, action module 226 may cause the arrival rate in the system-level queue to increase and/or it may communicate (e.g., via module 206) with at least one active processing node to inactivate or decommission the processing node(s).

In the scenarios of utilization being greater than the first threshold or less than the second threshold, action module 226 may also message or notify (e.g., via module 212) system administrators. Messages may also be sent when utilization is close to these thresholds. Based on this information, administrators may plan future hardware requirements, for example, additional or fewer processing nodes. Action module 226 may also perform various actions based on the average overall waiting time (e.g., as calculated by module 224). For example, the average overall waiting time may be provided (e.g., via module 212) periodically to administrators. Administrators may use this information to determine whether existing SLA's are being complied with or to plan future hardware requirements.

FIG. 3 is a block diagram of an example processing node 300 for multilevel load balancing. Processing node 300 may be similar to processing nodes 114, 116, 118 of FIG. 1A, for example. Processing node 300 may include a node-level queue 302 and a node-level-load balancer 304. Processing node 300 may include a job processing module 306 and an operating system 308. Processing node 300 may include at least one central processing unit (CPU), e.g., CPUs 310, 312, 314. In some embodiments, as explained above, where a CPU is indicated, a CPU core may be used instead.

Node-level queue 302 may be used by processing node 300 to receive jobs (e.g., from event receiver 200) and store them until they are pulled by, requested by or assigned to CPUs (e.g., 310, 312, 314). Node-level queue 302 may operate in a manner similar to system-level queue 202. For example, node-level queue 302 allow CPUs (e.g., 310, 312, 314) to receive jobs (e.g., via module 306 and operating system 308) from the node-level queue in a similar way that the system-level queue allowed processing nodes to request or pull jobs. Node-level queue 302 may receive jobs (e.g., from event receiver 200) at a specified arrival rate. Node-level queue 302 may set and maintain its own arrival rate. Node-level queue 302 may alter its arrival rate at various times and based on various input(s), e.g., input from module 326. Node-level queue 302 may provide its arrival rate (e.g., as a performance metric) to other modules of the processing node 300, for example, to module 322. Node-level queue 302 may include a series of instructions encoded on a machine-readable storage medium and executable by a processor accessible by the processing node. In addition or as an alternative, node-level queue 302 may include one or more hardware devices including electronic circuitry for implementing the functionality of the node-level queue described herein.

Job processing module 306 may pull or request jobs from node-level queue 302 and may assign each job to one of the CPUs available to the processing node (e.g., CPUs 310, 312, 314). Job processing module 306 may receive a signal from node a module of the processing node (e.g., module 320) that indicates whether the node is active. Job processing module 306 may only pull or request jobs if the node is active. Job processing module 306 may communicate with an operating system 308 of the processing node 300 to communicate with CPUs 310, 312, 314. Job processing module 306 may allow node-level load balancer 304 (e.g., via module 326) to alter the number of active/inactive CPUs (e.g., CPUs that are available to process jobs).

Job processing module 306 may include at least one application that is running on the processing node. The application may be the unit that is processing some or all of the jobs. For example, in the example scenario of the support request processing system, the application may be an application that analyzes support-related jobs and performs various tasks related to providing support, for example, opening a support ticket, sending message according to a subscription list, etc. Because the utilization of the processing node is determined based on metrics related to the node-level queue 302 and other metrics detected by job processing module 306 (e.g., refer to processing times as described more below), the processing node may take into account the processing speed of such an application as well as the processing speed of the individual CPUs. In this respect, the multilevel load balancing solutions provided herein are application aware.

Job processing module 306 may detect and/or determine processing times for jobs that are pulled from node-level queue 302. For example, job processing module 302 may detect the time at which a job is pulled from queue 302, and module 302 may detect when that job has been processed by one of the CPUs. The difference between those times indicates the processing time for that job (e.g., after the job left the queue 302). This processing time may be referred to as CPU processing time. Job processing module 306 may also determine an overall processing time for each job. For example, each job in queue 302 may be time stamped with a time when the job entered queue 302, and module 306 may detect when the job has been processed by one of the CPUs. The difference between those times indicates the overall processing time for that job (e.g., time in queue plus processing time after the job left the queue). Job processing module 306 may send both the CPU processing times (e.g., and/or raw time stamps) and the overall processing times (e.g., and/or raw time stamps) for various jobs to node-level load balancer 304 (e.g., to module 322).

Node-level load balancer 304 may facilitate (at least in part) the scheme for multilevel load balancing described herein. Node-level load balancer 304 may determine the utilization of the particular processing node. Node-level load balancer 304 may operate in a manner that is similar to system-level load balancer 204, for example. For example, node-level load balancer 204 may receive various metrics (e.g., arrival rate, at least one processing rate) from node-level queue 302 in order to determine the utilization. Node-level load balancer 304 may take various actions based on the utilization. For example, node-level load balancer 304 may cause (e.g., via module 326) the node-level queue 302 to alter its arrival rate. As another example, node-level load balancer 304 may cause (e.g., via module 326) more or less CPUs to be active (e.g., available to pull jobs from node-level queue 302). Node-level load balancer 304 may include a number of modules, for example, modules 320, 322, 324, 326. Node-level load balancer 304 (and various included modules such as modules 320, 322, 324, 326) may include a series of instructions encoded on a machine-readable storage medium and executable by a processor accessible by the processing node 300. In addition or as an alternative, node-level load balancer 304 (and various included modules such as modules 320, 322, 324, 326) may include one or more hardware devices including electronic circuitry for implementing the functionality described herein.

Similar to the system-level load balancer 204, node-level load balancer 304 may use a queuing theory to facilitate multilevel load balancing, as described herein. Node-level load balancer 304 may use queuing theory to analyze information and metrics about the processing node and the node-level queue to determine whether the processing node can handle the current workload with the current number of CPUs, arrival rate, etc. Node-level load balancer 304 may receive these metrics in real-time and may perform various actions to control the load on the processing node. Node-level load balancer 304 may use queuing theory to build a model of the processing node in a similar way to the way the system-level load balancer 204 builds a model of the system, except that instead of processing nodes being the processing units like in the system-level model, in the node-level model, CPUs are the processing units.

Commission/decommission module 320 may determine whether the processing node should be active or inactive. In alternate embodiments, commission/decommission module 320 may be external to node-level load balancer 304. Commission/decommission module 320 may receive a commission/decommission signal, for example, from processing nodes communication module 206 via operating system 206 and processing nodes interface 210. Commission/decommission module 320 may indicate to other modules of the processing node whether they should behave in an active or inactive manner. For example, commission/decommission module 320 may indicate to node-level queue 302 that it should (if active) or should not (if inactive) request or pull new jobs from the system-level queue. As another example, commission/decommission module 320 may indicate to job processing module 306 whether it should pull or request new jobs from node-level queue 302.

Metric collection module 322 may operate in a manner similar to metric collection module 220 of FIG. 2. For example, metric collection module 322 may receive and maintain various metrics that the node-level load balancer 304 may use to calculate various items (e.g., utilization of the processing node). Metric collection module 322 may receive a node-level arrival rate from node-level queue 302. Metric collection module 322 may receive processing times (e.g., CPU processing times and overall processing times) and/or raw time stamps for various jobs from module 306. Metric collection module 322 may compute average processing rates from the processing times and/or raw time stamps. For example, from the CPU processing times, module 322 may compute an average CPU processing time that indicates the number of jobs that the CPUs have processed over a period of time. Module 322 may send the CPU processing rates to module 324 determine the utilization of the processing node. For the overall processing times, module 322 may compute an average overall processing rate for the node (simply referred to as average processing rate once sent to event receiver). This may indicate the number of jobs that the processing node has processed over a period of time. Module 322 may send the average processing rate for the processing node to the event receiver (e.g., event receiver 204 via interface 210).

Utilization determination module 324 may determine the utilization of the processing node 300. Utilization determination module 324 may operate in a manner that is similar to utilization determination module 222 of FIG. 2. Again, the symbol ρ may be used to represent utilization of the processing node. Utilization generally indicates the ability of the processing node to handle incoming jobs at the current arrival rate. Similar to the system-level, at the node-level, utilization (ρ) may be based on the arrival rate (e.g., represented again by the symbol λ) of events into the processing node (e.g., into node-level queue 302) and an average CPU processing rate (e.g., each represented by the symbol μ). As shown in Eq. 6 below, utilization (ρ) may be calculated in a similar manner to the way it is calculated in Eq. 1 above, except that the term, s, may not be used.

$$ρ = \frac{λ}{s μ} \qquad ( Eq . 6 )$$

Utilization determination module 324 (or action module 326) may use the node-level utilization (ρ) to determine if the processing node is in a “steady state,” in a similar manner to the system-level utilization described above. For example, a first threshold of 0.9 and a second threshold of 0.6 may be used. If ρ is above the first threshold, this may indicate that the processing node is near collapse (e.g., unable to keep up with processing the incoming jobs at the current arrival rate). If ρ is below the second threshold, this may indicate that the processing node is underutilized.

Action module 326 may perform various actions depending on the node-level utilization (e.g., calculated by module 324). Action module 226 may receive the utilization (or some calculation or conclusion based on the utilization) from utilization determination module 324. In response to the utilization being greater than a first threshold, action module 326 may cause the node-level queue 302 to alter (e.g., reduce) its arrival rate. In response to the utilization being less than a second threshold, action module 326 may cause the node-level queue 302 to alter (e.g., increase) its arrival rate. Additionally or alternatively, action module 326 may communicate with job processing module 306 to activated or deactivate CPUs. Action module 326 may calculate the number of additional (or fewer) CPUs that are required to meet the current workload, and then may automatically activate or deactivate them. In this respect, both by adjusting the arrival rate and perhaps the number of active CPUs, each processing node is self-adjusting.

Individual processing nodes (e.g., 300) then communicate their ability to receive more or less jobs from the event receiver by adjusting their own arrival rate. In this respect, as explained above, the event receiver need only maintain minimal information about each processing node (e.g., number of active processing nodes). Additionally, more or less active processing nodes may be easily commissioned decommissioned. For example, when a processing node is transitioned from an inactive state to an active state, the processing node may automatically (e.g., via a module in the node-level load balancer) build a model for the processing node, and may automatically set its own arrival rate. Before a new node starts receiving real jobs from the event receiver, the new processing node may processes a number of test jobs in order to determine the processing rate of the processing node. Then the processing node may initialize its arrival rate based on the initial (e.g., test) processing rate. As the processing node starts receiving real jobs, it may then adjust its arrival rate. In this respect, each processing node self-initiates and self-adjusts itself, making addition and removal of active processing nodes into the system easy.

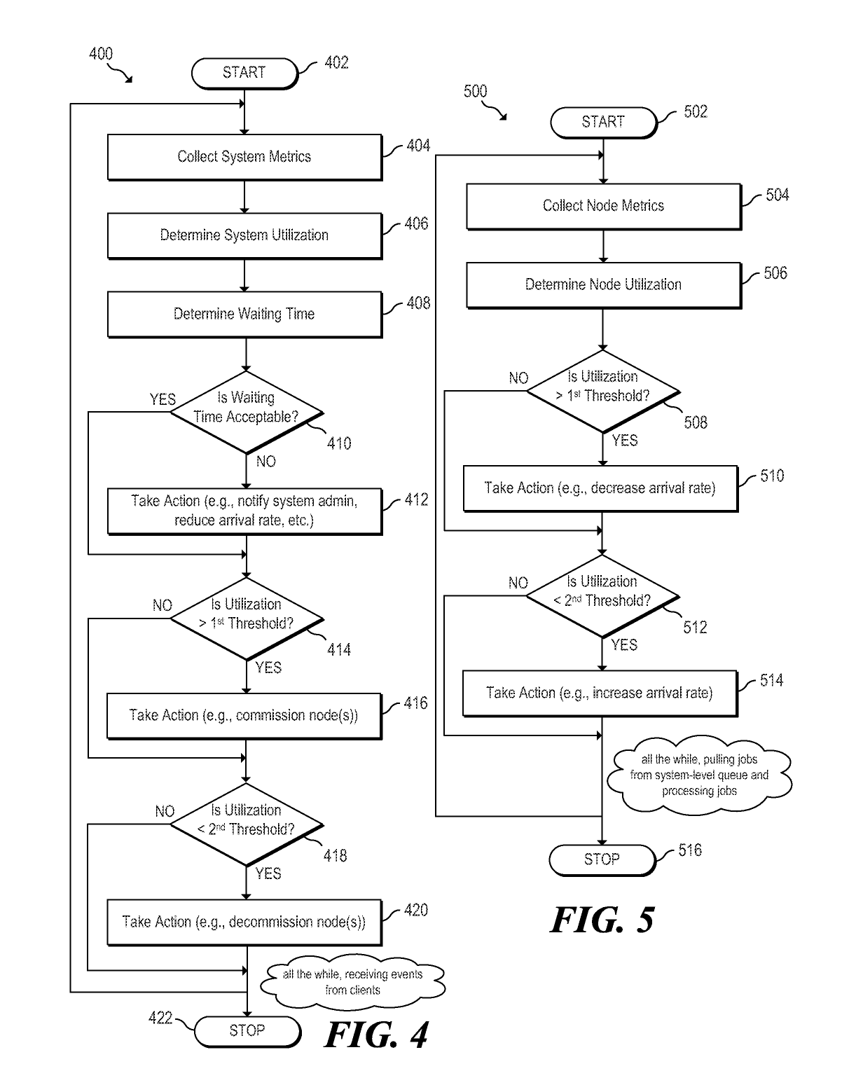

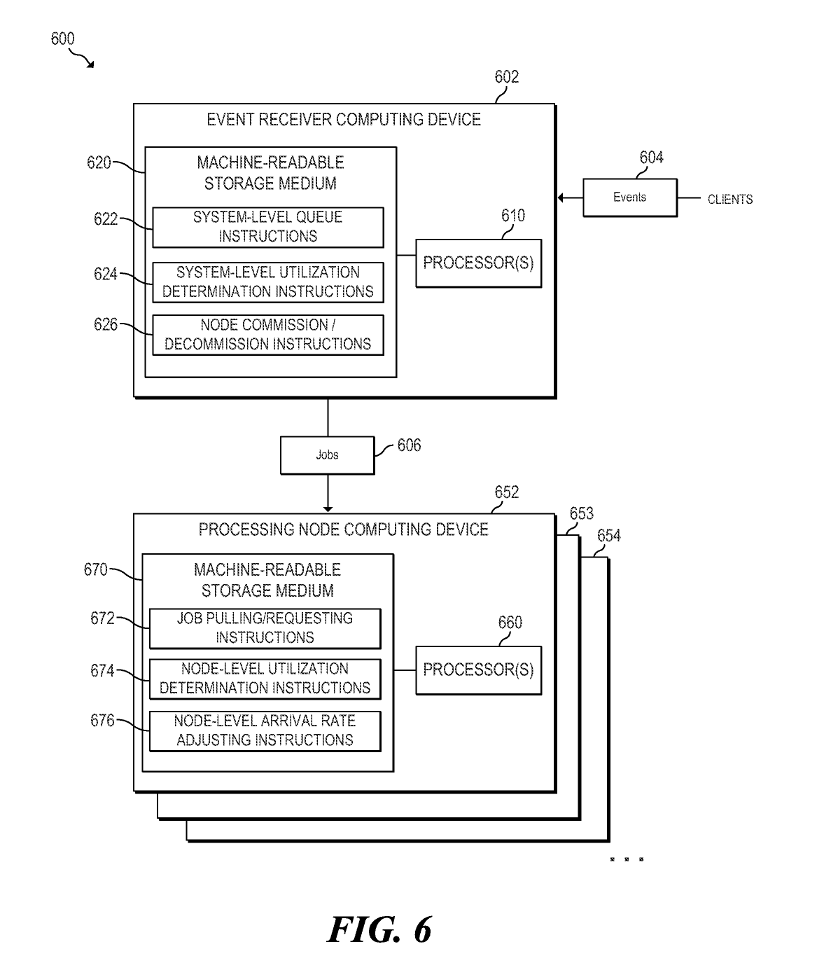

FIG. 4 is a flowchart of an example method 400 for multilevel load balancing. Method 400 may be executed by an event receiver of a processing system, for example, similar to event receiver 200 of FIG. 2. Method 400 may be executed by other suitable computing devices, for example, computing device 602 of FIG. 6. Method 400 may be implemented in the form of executable instructions stored on a machine-readable storage medium, such as storage medium 620, and/or in the form of electronic circuitry. In alternate embodiments of the present disclosure, one or more steps of method 400 may be executed substantially concurrently or in a different order than shown in FIG. 4. In alternate embodiments of the present disclosure, method 400 may include more or less steps than are shown in FIG. 4. In some embodiments, one or more of the steps of method 400 may, at certain times, be ongoing and/or may repeat. Additionally, during the execution of method 400, event receiver 200 may be receiving events from clients (e.g., clients 104, 106, 108)

Method 400 may start at step 402 and continue to step 404, where event receiver 200 may collect (e.g., via module 220) system metrics, for example, from system-level queue 202 and/or module 206. At step 406, event receiver 200 may determine (e.g., via module 222) overall utilization of the system. At step 408, event receiver 200 may determine (e.g., via module 224) average overall waiting time in the system. At step 410, event receiver 200 may determine (e.g., via module 226) whether the waiting time is acceptable. If the waiting time is not acceptable, method 400 may proceed to step 412 where event receiver 200 may take action (e.g., via module 226), for example by notifying system administrators, reducing the system-level arrival rate, etc. At step 410, if the waiting time is acceptable, method 400 may proceed to step 414. At step 414, event receiver 200 may determine (e.g., via module 226) whether the utilization is greater than a first threshold (e.g., 0.9). If it is, method 400 may proceed to step 416, where event receiver 200 may take action (e.g., via module 226), for example by commissioning new processing nodes and/or decreasing the system-level arrival rate. At step 414, if utilization not greater than the first threshold, method 400 may proceed to step 418. At step 418, event receiver 200 may determine (e.g., via module 226) whether the utilization is less than a second threshold (e.g., 0.6). If it is, method 400 may proceed to step 420, where event receiver 200 may take action (e.g., via module 226), for example by decommissioning at least one active processing node and/or increasing the system-level arrival rate. At step 418, if utilization not less than the second threshold, method 400 may proceed back to step 404 or to step 422. Method 400 may eventually continue to step 422, where method 400 may stop.

FIG. 5 is a flowchart of an example method 500 for multilevel load balancing. Method 500 may be executed by a processing node of a processing system, for example, similar to processing node 300 of FIG. 3. Method 500 may be executed by other suitable computing devices, for example, computing device 652 of FIG. 6. Method 500 may be implemented in the form of executable instructions stored on a machine-readable storage medium, such as storage medium 670, and/or in the form of electronic circuitry. In alternate embodiments of the present disclosure, one or more steps of method 500 may be executed substantially concurrently or in a different order than shown in FIG. 5. In alternate embodiments of the present disclosure, method 500 may include more or less steps than are shown in FIG. 5. In some embodiments, one or more of the steps of method 500 may, at certain times, be ongoing and/or may repeat. Additionally, during the execution of method 500, processing node 300 may be receiving jobs from an event receiver (e.g., 200 of FIG. 2)

Method 500 may start at step 502 and continue to step 504, where processing node 300 may collect (e.g., via module 322) node-level metrics, for example, from node-level queue 302 and/or module 306. At step 502, processing node 300 may also determine an average processing rate for the processing node, and may communicate such average processing rate to the event receiver. At step 506, processing node 300 may determine (e.g., via module 324) utilization of the processing node. At step 508, processing node 300 may determine (e.g., via module 326) whether the utilization is greater than a first threshold (e.g., 0.9). If it is, method 500 may proceed to step 510, where processing node 300 may take action (e.g., via module 326), for example by decreasing the node-level arrival rate and/or activating at least one additional CPU. At step 508, if utilization not greater than the first threshold, method 500 may proceed to step 512. At step 512, processing module 300 may determine (e.g., via module 326) whether the utilization is less than a second threshold (e.g., 0.6). If it is, method 500 may proceed to step 514, where processing node 300 may take action (e.g., via module 326), for example by increasing the node-level arrival rate and/or inactivating at least one active CPU. At step 512, if utilization not less than the second threshold, method 500 may proceed back to step 504 or to step 516. Method 500 may eventually continue to step 516, where method 500 may stop.

FIG. 6 is a block diagram of an example event receiver computing device 602 in communication with at least one example processing node computing device (e.g., 652, 654, 656), which all make up an example processing system 600 for multilevel load balancing. Event receiver computing device 602 may be any computing device capable of receiving events from clients and sending jobs to processing nodes. Processing node computing device 652, for example, may be any computing device capable of receiving jobs from event receiver 602 and processing such jobs. In some embodiments, event receiver computing device 602 and processing node computing device 652 may be the same computing device. In some embodiments, processing node computing devices 652, 654, 656 may be the same computing device. More details regarding an example event receiver and an example processing node may be described herein, for example, with respect to event receiver 200 of FIG. 2 and processing node 300 of FIG. 3. In the embodiment of FIG. 6, event receiver computing device 602 includes at least one processor 610 and a machine-readable storage medium 620. Likewise, processing node computing device 652 includes at least one processor 660 and a machine-readable storage medium 670.

Processor(s) 610 and 660 may each be one or more central processing units (CPUs), CPU cores, microprocessors, and/or other hardware devices suitable for retrieval and execution of instructions stored in a machine-readable storage medium (e.g., 620 and 670). Processor(s) 610 and 660 may each fetch, decode, and execute instructions (e.g., instructions 622, 624, 626 and instructions 672, 674, 676 respectively) to, among other things, perform multilevel load balancing. With respect to the executable instruction representations (e.g., boxes) shown in FIG. 6, it should be understood that part or all of the executable instructions included within one box may, in alternate embodiments, be included in a different box shown in the figures or in a different box not shown.

Machine-readable storage mediums 620 and 670 may each be any electronic, magnetic, optical, or other physical storage device that stores executable instructions. Thus, machine-readable storage mediums 620 and 670 may each be, for example, Random Access Memory (RAM), an Electrically-Erasable Programmable Read-Only Memory (EEPROM), a storage drive, an optical disc, and the like. Machine-readable storage mediums 620 and 670 may each be disposed within a computing device (e.g., 602, 652), as shown in FIG. 6. In this situation, the executable instructions may be “installed” on the computing device. Alternatively, machine-readable storage mediums 620 and 670 may each be a portable (e.g., external) storage medium, for example, that allows a computing device (e.g., 602, 652) to remotely execute the instructions or download the instructions from the storage medium. In this situation, the executable instructions may be part of an installation package. As described in detail below, machine-readable storage mediums 620 and 670 may each be encoded with executable instructions for multilevel load balancing.

Event receiver computing device 602 may receive events 604 from various clients (e.g., client devices). System-level queue instructions 622 may be executed to maintain a system-level queue and to store events or jobs in the system level queue, for example, as explained in more detail above with regard to system-level queue 152 of FIG. 18 and/or system-level queue 202 of FIG. 2. System-level utilization determination instructions 624 may be executed to determine the overall utilization of the processing system, for example, as explained in more detail above with regard to modules 220 and 222 of system-level load balancer 204 of FIG. 2. Node commission/decommission instructions 626 may activate inactive processing nodes (e.g., based on the overall utilization) and/or may deactivate active processing nodes, for example, as explained in more detail above with regard to module 226 of system-level load balancer 204 of FIG. 2, and perhaps additionally module 206, operating system 208 and processing nodes interface 210. Event receiver computing device 602 may send jobs 606 to at least one processing node computing device, for example, processing node computing device 652.

Processing node computing device 652 may receive jobs 606 from event receiver 602. Job pulling/requesting instructions 672 may be executed to cause processing node computing device 652 to pull or request jobs from the system-level queue of event receiver computing device 602, for example, as explained in more detail above with regard to node-level queue 302 of FIG. 3. Node-level utilization determination instructions 674 may be executed to determine the utilization of processing node computing device 652, for example, as explained in more detail above with regard to modules 322 and 324 of node-level load balancer 304 of FIG. 3. Node-level arrival rate adjusting instructions 676 may be executed to adjust the arrival rate of processing node computing device 652, for example, as explained in more detail above with regard to module 326 of node-level load balancer 304.

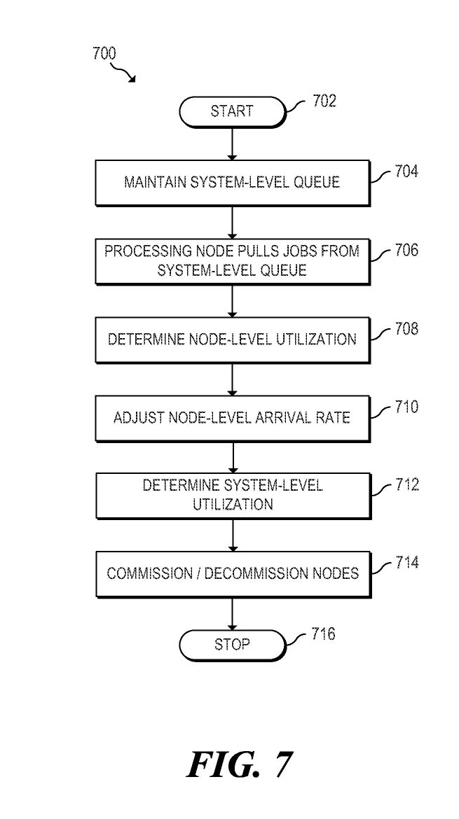

FIG. 7 is a flowchart of an example method 700 for multilevel load balancing. Method 700 may be executed by an event receiver and/or at least one processing node of a processing system, for example, similar to processing system 600 of FIG. 6. Method 700 may be executed by other suitable systems, for example, systems 100 and 150 of FIGS. 1A and 1B. Method 700 may be implemented in the form of executable instructions stored on a machine-readable storage medium, such as storage mediums 620 and/or 670, and/or in the form of electronic circuitry. In alternate embodiments of the present disclosure, one or more steps of method 700 may be executed substantially concurrently or in a different order than shown in FIG. 7. In alternate embodiments of the present disclosure, method 700 may include more or less steps than are shown in FIG. 7. In some embodiments, one or more of the steps of method 700 may, at certain times, be ongoing and/or may repeat.

Method 700 may start at step 702 and continue to step 704, where processing system 600 may maintain (e.g., via instructions 622) a system-level queue. Processing system 600 may receive events from clients and store them in the system-level queue. At step 706, processing system 600 (via at least one processing node) may pull (e.g., via instructions 672) jobs from the system-level queue. At step 708, processing system 600 may determine (via at least one processing node, e.g., via instructions 674) the node-level utilization of the particular processing node(s). At step 710, processing system 600 may adjust (via at least one processing node, e.g., via instructions 676) the node-level arrival rate of the particular processing node(s). At step 712, processing system 600 may determine (e.g., via instructions 624) a system-level utilization. At step 714, processing system 600 may, based on the system-level utilization, commission or decommission (e.g., via instructions 626) at least one processing node. Method 700 may eventually continue to step 716, where method 700 may stop.

1. A system for multilevel load balancing, the system comprising:
at least one processor to:
maintain a system-level queue of jobs, the jobs being based on events received from client devices;
maintain a pool of active processing nodes, each active processing node in the pool to:
pull jobs from the system-level queue at an arrival rate for the particular active processing node,
determine a node-level utilization that indicates the particular active processing node's capacity to process jobs at the arrival rate, and
adjust the arrival rate based on the node-level utilization; and
determine a system-level utilization based the number of active processing nodes in the pool and average processing rates of the active processing nodes in the pool, wherein each average processing rate indicates the time it takes the particular active processing node to process jobs once pulled from the system-level queue.

2. The system of claim 1 wherein the at least one processor is further to, based on the system-level utilization, either dynamically add an active processing node to the pool or dynamically remove an active processing node from the pool.

3. The system of claim 1, wherein the average processing rates for the active processing nodes are anonymous, meaning that the determination of the system-level utilization does not consider whether the average processing rates are associated with a particular one of the active processing nodes.

4. The system of claim 1, wherein each active processing node in the pool is further to place pulled jobs into a node-level queue for the particular active processing node, wherein the node-level utilization for the particular active processing node is based on a CPU processing rate that indicates the time it takes the particular active processing node to process jobs once pulled from the node-level queue.

5. The system of claim 4, wherein, the node-level utilization for the particular active processing node is further based on the arrival rate for the particular active processing node.

6. The system of claim 1, wherein for each active processing node in the pool, the arrival rate adjustment is either to decrease the arrival rate if the node-level utilization is above a first threshold or to increase the arrival rate if the node-level utilization is below a second threshold.

7. The system of claim 6, wherein for each active processing node in the pool, the node-level utilization is a number between 0 and 1, and wherein the first threshold is approximately 0.9, and wherein the second threshold is approximately 0.6.

8. The system of claim 2, wherein the dynamic addition of an active processing node to the pool occurs when the system-level utilization is above a first threshold, and wherein the dynamic removal of an active processing node from the pool occurs when the system-level utilization is below a second threshold.

9. The system of claim 8, wherein the system-level utilization is a number between 0 and 1, and wherein the first threshold is approximately 0.9, and wherein the second threshold is approximately 0.6.

10. A method for multilevel load balancing, the method comprising:
maintaining a system-level queue of jobs, the jobs being based on events received from client devices;
maintaining a pool of processing nodes, each processing node in the pool being either active or inactive, wherein each active processing node in the pool is capable of pulling jobs from the system-level queue, placing jobs into a node-level queue for the particular processing node, and processing jobs;
determining, by a first active processing node in the pool, a node-level utilization that indicates the capability of the first active processing node to process jobs, and an average processing rate that indicates the time it takes the first active processing node to process jobs once pulled from the system-level queue;
adjusting, by the first active processing node, a node-level arrival rate based on the node-level utilization, wherein the node-level arrival rate affects the rate at which the first active processing node pulls jobs from the system-level queue; and
determining a system-level utilization that indicates the capability of the system to receive new events from the client devices, wherein the system-level utilization is based on the average processing rate for the first active processing node and average processing rates of other active processing nodes in the pool.

11. The method of claim 10, further comprising, based on the system-level utilization, either dynamically activating at least one inactive processing node of the pool or dynamically inactivating at least one active processing node of the pool.

12. The method of claim 10, wherein the first active processing node is running an application that processes jobs in the node-level queue associated with the first active processing node, and wherein the node-level utilization is based on the processing speed of the application.

13. The method of claim 10, further comprising determining a system-level average waiting time to process received events from clients, wherein the average waiting time is based on the average processing rate for the first active processing node and the average processing rates of the other active processing nodes in the pool, and further based on a system-level arrival rate that indicates the rate at which events are received from clients.

14. The method of claim 13, further comprising sending the system-level average waiting time to at least one system administrator.

15. A machine-readable storage medium encoded with instructions executable by at least one processor of a processing node computing device for multilevel load processing, the machine-readable storage medium comprising:
for a first processing node of a pool in a processing system:
instructions to receive jobs, at an arrival rate, from a system-level queue, wherein the jobs are received in response to requests by the first processing node;
instructions to maintain a node-level queue and placing the received jobs into the node-level queue;
instructions to determine a node-level utilization that indicates the capacity of the first processing node to process jobs at the arrival rate;
instructions to adjust the arrival rate based on the node-level utilization; and
instructions to determine an average processing rate that indicates the time it takes to process jobs once pulled from the system-level queue, wherein the average processing rate is used, along with average processing rates from other processing nodes of the pool, to determine a system-level utilization.

16. The machine-readable storage medium of claim 15, wherein the system-level utilization is used by the system to either activate at least one inactive processing node of the pool or inactivate at least one active processing node of the pool.

17. The machine-readable storage medium of claim 15, wherein the instructions to adjust the arrival rate either decrease the arrival rate if the node-level utilization is above a first threshold or increase the arrival rate if the node-level utilization is below a second threshold.

18. The machine-readable storage medium of claim 17, wherein the node-level utilization is a number between 0 and 1, and wherein the first threshold is approximately 0.9, and wherein the second threshold is approximately 0.6.
